(19) United States
(12) Patent Application Publication
(10) Pub. No.: US 2004/0215601 A1
(43) Pub. Date: Oct. 28, 2004

(54) Method of file management using a computer

(76) Inventors: Win-Harn Liu, Taipei (TW); Jeff Song, Taipei (TW); Ye Li, Tianjin (CN)

Correspondence Address: BIRCH STEWART KOLASCH & BIRCH, PO BOX 747, FALLS CHURCH, VA, 22040-0747, US

(21) Appl. No.: 10/420,695

(22) Filed: Apr. 23, 2003

(51) Int. Cl. G06F 7/00

(52) U.S. Cl. 707/3

(57) ABSTRACT

A method of file management using a computer is disclosed. The initial file and file search of each project are used to update file information and set up an index table. The method also provides the sending and inquiry of file update information. To achieve the above result, the disclosed method covers two aspects: data management and data extraction. In the respect of data management, the initial file and the file search and extraction are used to update the index table in a database, and the updated index table is sent to the manager. In the respect of data extraction, a search criterion is entered for searching files and the searched result is sent to the inquirer via mail.

### BACKGROUND OF THE INVENTION

1. Field of Invention

The invention relates to a method of file management using a computer and, in particular, to a method of file management that utilizes computerized data indexing.

2. Related Art

If there is no proper control and management tool integrated with various high-speed and highly efficient computer hardware devices, then the computer cannot exhibit its full abilities. Therefore, such control and management tools are of great consequence. These computer control and management tools are called in general software.

Every computer software company is producing/modifying a huge amount of program codes and documents. Obviously, it is very common in teamwork that many people are involved in one subject and each person is involved in several subjects. Therefore, how to make sensible management of produced or modified program codes to prevent the situations that somebody concentrates on his own work so much that he or she overlooks the same or similar efforts that other people have done. To avoid such unnecessary overlapped labor, the manager has to be able to understand and control the program codes, making immediate and appropriate adjustments for different parts of each subject and among different subjects. The objective is to make the most of available resources.

Most of currently available management tools use individual subjects as the unit. They do not have the ability to make comparison among different subjects. In this environment, not only are the members in each project hard to understand the essence of their project and available resources, it is also very difficult for the manager to control and compare. It is thus imperative to establish a method or means to manage the cases and program modules.

### SUMMARY OF THE INVENTION

In view of the foregoing, the invention provides a method of file management using computers based upon current file management knowledge. An update command starts an update process for file information. New file information and index table are established with the help of the initial file of each project and file searches. Such information and index table are then distributed and used for inquiries.

An objective of the invention is to provide a computerized file management method, through which one is able to quickly extract a desired module program and apply it to other modules.

To achieve the above objective, the disclosed method includes two aspects: data management and data extraction. In the respect of data management, a source code management program searches for file information in an index table. The obtained file information is then used to search for new file information. The new file information is incorporated to make modifications in the old index table, producing a new index table. Finally, the new index table is attached to an E-mail and the E-mail is sent to the manager.

In the respect of data extraction, the user first enters a search criterion. The system then searches the index table according to the input inquiry information and displays its search result. The individual file content is further displayed according to the user's choice. Afterwards, the system provides an extraction command and executes it. The extracted file is then attached to an E-mail that is subsequently sent to the inquiring user.

### BRIEF DESCRIPTION OF THE DRAWINGS

The invention will become more fully understood from the detailed description given hereinbelow illustration only, and thus are not limitative of the present invention, and wherein:

FIG. 1 is an operational flowchart showing file update and management of the disclosed database;

FIG. 2 is an operational flowchart of extracting files from the database;

FIG. 3 shows the structure of the disclosed file management system;

FIG. 4 is a module file explanation list in an embodiment of the invention;

FIG. 5 is a module file storage location list in an embodiment of the invention; and

FIG. 6 is a module file partial content list in an embodiment of the invention.

### DETAILED DESCRIPTION OF THE INVENTION

We describe a method of file management using a computer. The update process is started by an update command. The method uses the initial file of each project and file searches to update file information and establish an index table. The updated file information is further distributed and used for inquiries. Through the operations disclosed in the method, it can achieve the objective of quickly extracting a desired module program and applying it to other module programs. The disclosed method is described in the following paragraphs in three aspects: database setup, data management, and data extraction.

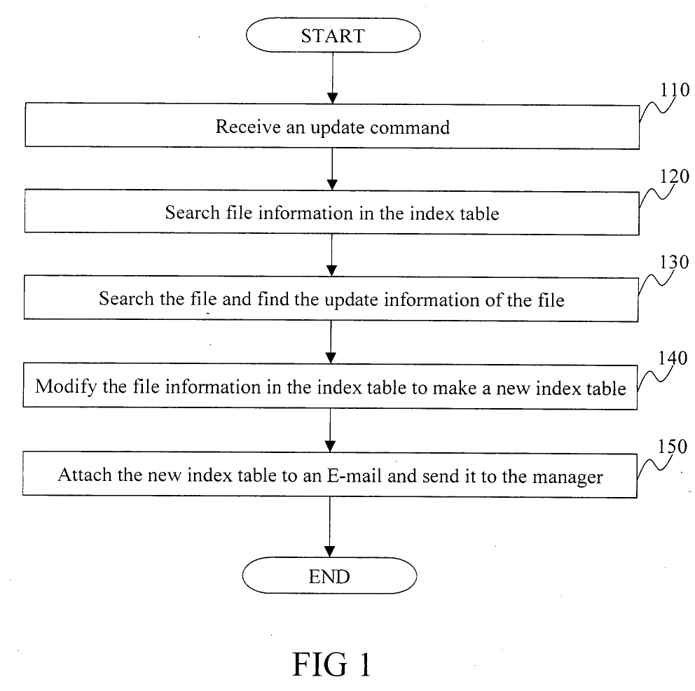

In the respect of data management, please refer to FIG. 1. When the source code management program such as Source Safe receives a data update command (step 110), it immediately starts to search for the file information of each project in an index table (step 120). It further searches for the initial file of each project according to the file location recorded in the project index table and the update information thereof (step 130). After the search and extraction actions, the obtained update information is then used to modify the file information stored in the index table, making a new index table (step 140). After the data in the index table are all updated, the new index table is attached to an E-mail that is sent to the manager at once (step 150). The manager can learn the work progress and module attributes of each program module from the message.

The above-mentioned file information include subject names, module names, subject explanations, document names, document locations, document initial codes, function names, function initial codes, coding environments, coding author, and latest coding time. The updating of files in the database can be controlled through a time setting so that the control system provides the latest file information to the manager periodically.

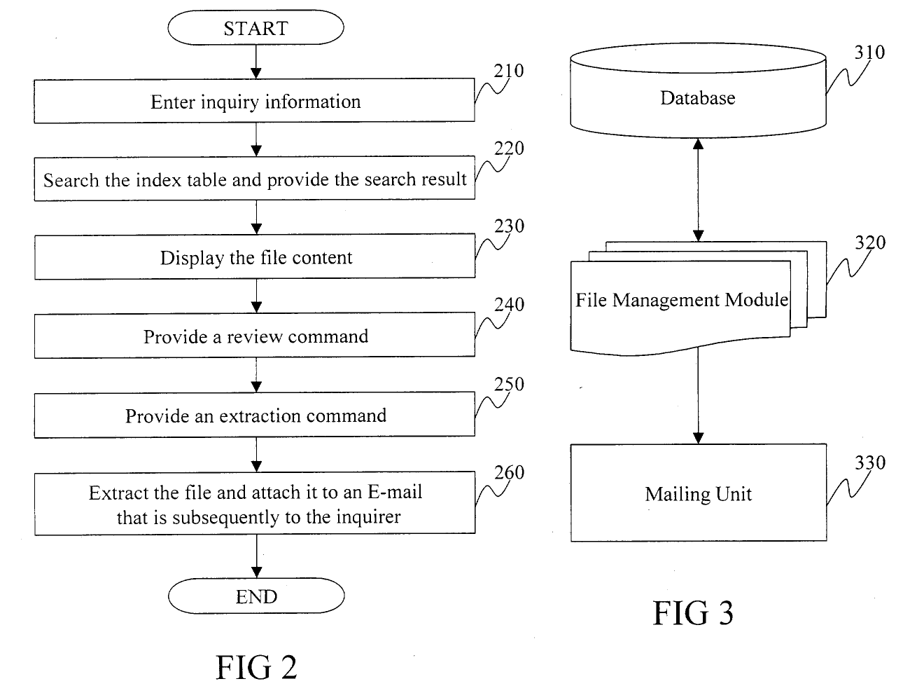

In the respect of data extraction, please refer to FIG. 2. The file management system first asks the user to input inquiry information (step 210), and searches the index table accordingly to provide a searched result (step 220). The user selects a file from the searched result provided by the file management system to review. Once the file is selected, the file management system immediately displays the file content (step 230) and further provides a review command (step 240) and an extraction command (step 250). The inquirer can use the review command to analyze the program structure or content of the file. If the file has been modified, different versions of modification information are displayed in different colors to highlight the modified content. When the file content satisfies the inquirer's request, the inquirer can use the extraction command provide by the file management system to obtain the file and attach it to an E-mail that is then sent to the inquirer (step 260). The inquirer then uses the information to perform necessary operations.

After describing the disclosed method, we use FIG. 3 to show the file management system structure. The file management system is comprised of a database 310, a file management module 320, and a mailing unit 330.

The database 310 stores the index table. The file management module 320 updates and builds the index table and accepts inquiries from users for files. It further updates the index table periodically or at certain times to provide the manager the latest work progress. The mailing unit 330 receives files output from the file management module 320 and attaches it to an E-mail that is then sent to the inquirer or manager.

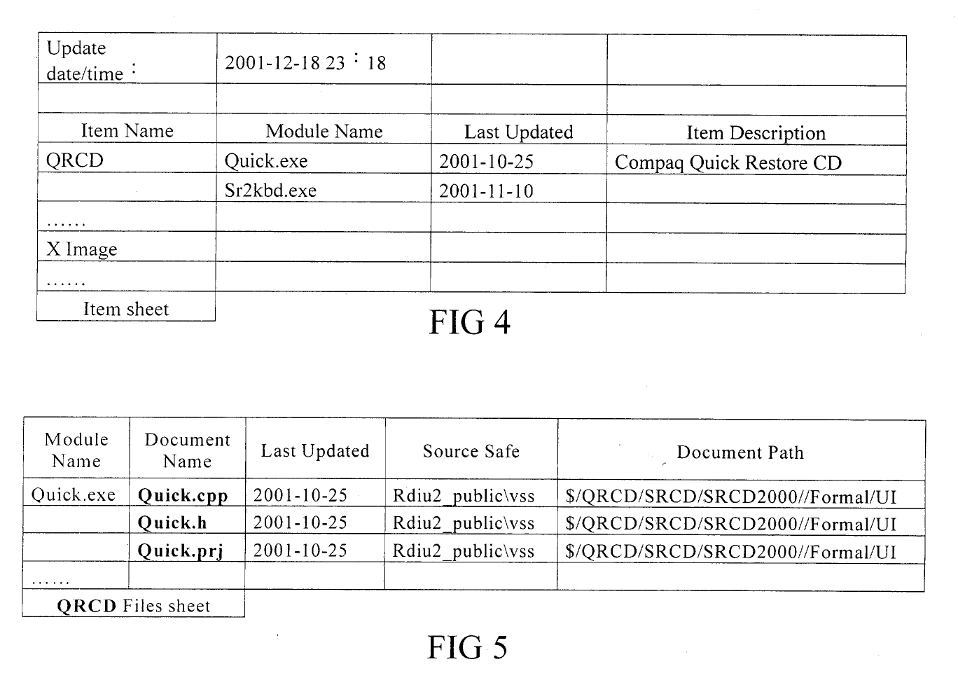

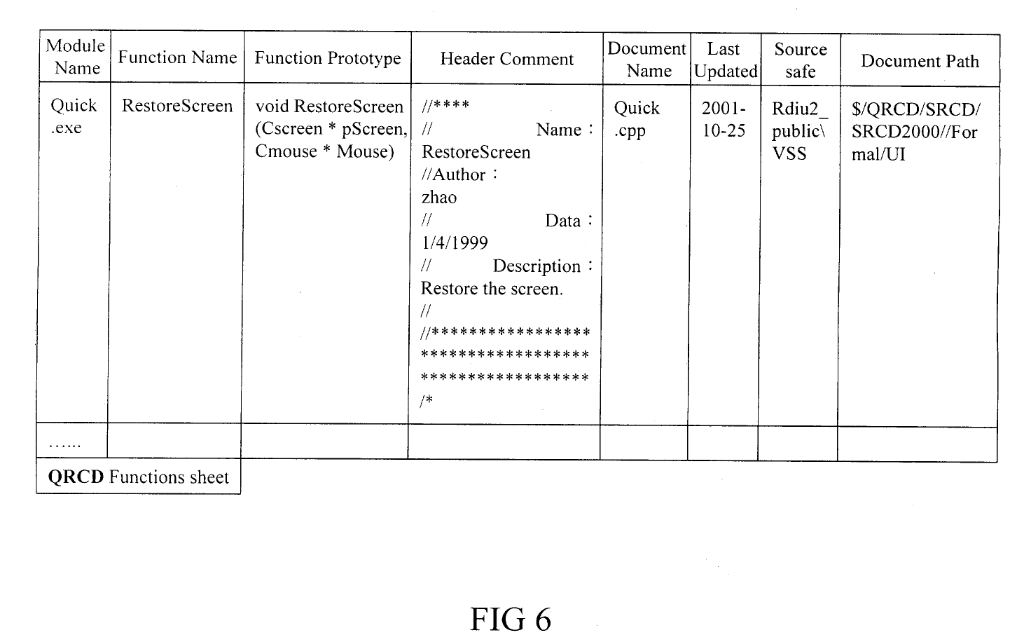

In the above explanation of the method procedure and system structure, the index table has three types of lists. They are respectively the module file explanation list in FIG. 4, the module file storage location list in FIG. 5, and the module file partial content list in FIG. 6. The three lists have hierarchies. Through the three lists, the inquirer can roughly understand the module function, storage location, and the latest modification time.

What is claimed is:

1. A method of file management using computers for managing source codes in a database, the method comprising the steps of:
searching file information in an index table using a source code management program;
searching new file information of a file according to the file information;
modifying the index table according to the new file information and making a new index table; and
attaching the new index table in an E-mail that is subsequently sent to a manager.

2. The method of claim 1, wherein the index table is formed using the source code management program to read an initial file and the associated file.

3. The method of claim 2, wherein the source code management program is Source Safe software.

4. The method of claim 1, wherein the file information and the new file information contains elements selected from the group consisting of a subject name, a module name, a subject explanation, a document name, a document location, a document initial code, a function name, a function initial code, a coding environment, a coding author, and a latest coding time.

5. The method of claim 1 further comprising the step of setting data update time.

6. A method of file management using computers for file extraction from a database, the method comprising the steps of:
entering inquiry information;
searching an index table according to the inquiry information and providing a search result;
displaying a file content according to the search result;
providing a review command according to the file content;
providing an extraction command according to the review command; and
obtaining a file according to the extraction command and attaching the file to an E-mail that is subsequently sent to an inquirer.

7. The method of claim 6, wherein the index table is formed using the source code management program to read an initial file and the associated file.

8. The method of claim 7, wherein the source code management program is Source Safe software.

9. The method of claim 6, wherein the file information and the new file information contains elements selected from the group consisting of a subject name, a module name, a subject explanation, a document name, a document location, a document initial code, a function name, a function initial code, a coding environment, a coding author, and a latest coding time.

10. The method of claim 6, wherein when the file content is modified different versions of the content are displayed in different colors.
